(19) United States
(12) Patent Application Publication
(10) Pub. No.: US 2016/0117797 A1
(43) Pub. Date: Apr. 28, 2016

(54) Image Processing Apparatus and Image Processing Method

(71) Applicant: HITACHI, LTD., Tokyo (JP)

(72) Inventors: Zisheng LI, Tokyo (JP); Tsuneya KURIHARA, Tokyo (JP)

(21) Appl. No.: 14/896,160

(22) PCT Filed: Jun. 6, 2013
(86) PCT No.: PCT/JP2013/065737

§ 371 Date: Dec. 4, 2015

(51) Int. Cl. G06T 3/00; G06K 9/46; G06K 9/62; G06T 7/00

(52) U.S. Cl. CPC G06T 3/0093; G06T 7/0028; G06K 9/4604; G06T 3/0068; G06K 9/6215; G06T 7/0012; G06T 2207/10016

(57) ABSTRACT

In an image processing apparatus which performs registration between a referring image and a moving image, the image processing apparatus sets a control grid on the moving image in order to deform the moving image. The image processing apparatus extracts feature points from the moving image and the referring image, respectively. The apparatus searches positions corresponding to the extracted feature points from the referring image and the moving image. The apparatus sets the initial positions of control points on the control grid set on the moving image by using the searched-out positions. The extracted feature points correspond to each other on the referring image and the moving image, respectively, and are feature portions on the respective images.

### TECHNICAL FIELD

The present invention relates to an image processing apparatus and an image processing method, and, more particularly, the present invention relates to an image processing apparatus and image processing method which perform registration among a plurality of images.

### BACKGROUND ART

A technique of registering a plurality (hereinafter, also referred to as a plural photographs) of two-dimensional or three-dimensional images is used in various fields, and is an important technique. For example, in the field of medical images, various types of three-dimensional images such as a CT (Computed Tomography) image, a MR (Magnetic Resonance) image, a PET (Positron Emission Tomography) image, and an ultrasonic image are acquired. For the various types of the acquired three-dimensional images, an image registration technique is used in order to register and superimpose the images for the display. Such a display method is called fusion image display, which enables such display as capturing the feature of the images. For example, the CT image is suitable to display detailed shapes, and the PET image is suitable to display human body functions such as metabolism and blood flow.

In addition, in the medical field, a state of a lesion can be observed in time series so that the presence/absence of a disease or progress of the same can be diagnosed by registration among a plurality of frames of medical images acquired in time series in order to observe a disease progression of the same patient. In the registration among the plurality of images, a fixed image is called a referring image, and an image whose coordinates are converted for the registration is called a moving image.

The techniques for the registration among the plurality of images can be classified into a rigid registration method and a non-rigid registration method. In the rigid registration method, the images are registered by parallel movement and rotation of the images. This method is suitable for an image of a region which does not easily deform, such as a bone. On the other hand, in the non-rigid registration method, it is required to obtain the correspondence relationship between images by performing complicated deformation including local deformation to the images. Therefore, this method is applied to the registration of a plurality of frames of medical images acquired in treatment planning and/or follow-up, or is applied to the registration among the medical images such as the registration between a standard human body/organ model and an individual model, and therefore, has a wide range of the applications.

In a generally-known non-rigid registration method, the moving image is deformed by arranging a control grid on a moving image and moving control points on the control grid. An image similarity is obtained between the deformed moving image and a referring image, optimization calculation based on the obtained image similarity is performed, and a movement amount (deformation amount) of control point on the control grid is obtained. In this case, a movement amount of a pixel between the control points on the control grid is calculated by interpolation based on the movement amounts of the control points arranged in periphery of the pixel. The coordinates of the moving image are converted by using the obtained movement amount of each pixel, so that such registration as locally deforming an image is executed. In addition, multiresolution deformation can be executed by changing an interval between the control points, i.e., the number of grid points.

Patent Document 1 describes that, on a moving image, not the grid control point but a landmark corresponding to a region similar to that on a referring image is used as the control point, and that the image is subjected to tile division (segmentation) to be deformed by using the control point. When local deformation is desired, a landmark is added into the divided tiles, the image is further subjected to the tile division, so that the registration is executed.

### PRIOR ART DOCUMENT

### Patent Document

Patent Document 1: Japanese Patent Application Laid-Open Publication (Translation of PCT Application) No. 2007-516744

### SUMMARY OF THE INVENTION

### Problems to be Solved by the Invention

In the above-described registration using the control grid, the number of control points on the control grid reaches about several-thousand or several-ten-thousand order. Therefore, optimization calculation for obtaining the movement amount of each control point is complicated. Therefore, registration accuracy depends on the initial positions of the control points on the control grid. By using the above-described rigid registration method, the initial position of each of the control points can be roughly set. However, a case of occurrence of complicated deformation due to temporal changes in soft tissues and organs has a possibility that the rigid registration method itself cannot be applied to the case. Therefore, it is difficult to obtain a correct initial position.

In addition, when a registration result is corrected, it is required to move a plurality of control points on the control grid to corresponding positions one by one. This operation is very complicated.

On the other hand, in the technique described in Patent Document 1, when complicated local deformation is desired, a processing of sequentially adding landmarks and dividing tiles is required. However, when the areas of tile regions are reduced by the division processing, it is difficult in existing tiles to accurately search the corresponding points in an anatomic region. In addition, in the processing of the sequential addition of the landmarks, a robust erroneous-support exclusion processing using the matching degree of the entire landmarks is difficult.

An object of present invention is to provide an image processing apparatus and an image processing method which have high registration processing accuracy.

The above and other object and novel characteristics of the present invention will be apparent from the description of the present specification and the accompanying drawings.

### Means for Solving the Problems

The summary of the typical one of the inventions disclosed in the present application will be briefly described as follows.

That is, in order to deform the moving image, the control grid is set on the moving image. In addition, from each of the moving image and the referring image, a feature point (hereinafter, also referred to as landmark) is extracted. Points at positions corresponding to the extracted feature points are searched out from each of the referring image and the moving image. The initial positions of control points on the control grid set on the moving image are set by using the searched-out points. The respective extracted feature points on the referring image and the moving image correspond to each other (are paired), and are feature parts on the respective images. In this manner, the positions corresponding to the respective feature points corresponding to each other (positions on the referring image and the moving image) are reflected on the initial positions of the control points. Before deforming the moving image for the registration, the control points can be arranged at more correct positions, so that the registration accuracy can be improved.

In addition, according to an embodiment, feature points are manually inputted (edited). From this result, a registration result can be corrected by deforming the control grid, so that the correction can be facilitated.

### Effects of the Invention

According to an embodiment, an image processing apparatus and an image processing method which have high registration processing accuracy can be provided.

### BRIEF DESCRIPTIONS OF THE DRAWINGS

FIG. 1 is a block diagram illustrating a logical configuration of an image processing apparatus according to a first embodiment;

FIG. 2 is a block diagram illustrating a hardware configuration of the image processing apparatus according to the first embodiment;

FIG. 3 is a flowchart illustrating a registration processing according to the first embodiment;

FIG. 4 is a data structure diagram illustrating a three-dimensional image of a data structure of feature points according to the first embodiment as an example;

FIG. 5 is a flowchart illustrating a processing performed by a registering unit according to the first embodiment;

FIG. 6 is a block diagram illustrating a logical configuration of an image processing apparatus according to a second embodiment;

FIG. 7 is a flowchart illustrating a processing performed by an interest region extracting unit according to the second embodiment;

FIGS. 8A-8C are explanatory diagrams each illustrating an example of images processed by the image processing apparatus according to the second embodiment;

FIG. 9 is a block diagram illustrating a logical configuration of an image processing apparatus according to a third embodiment;

FIGS. 10A AND 10B are schematic diagrams of a transverse plane slice of an abdominal region of a human body;

FIGS. 11A AND 11B are schematic diagrams of a transverse plane slice of the abdominal region of the human body to which a landmark is added;

FIGS. 12A AND 12B are schematic diagrams each illustrating a relation between a control grid and a transverse plane slice of the abdominal region of the human body;

FIG. 13 is a schematic view illustrating a transverse plane slice of the abdominal region of the human body which is deformed by a control grid;

FIGS. 14A AND 14B are schematic diagrams of a transverse plane slice of the abdominal region of the human body, which clearly specifies an example of sampling points; and

FIGS. 15A AND 15B are schematic diagrams of a transverse plane slice of the abdominal region of the human body to which landmarks and a control grid are added; and

FIG. 16 is a data structure diagram illustrating a data structure of a corresponding-point pair according to each embodiment.

### BEST MODE FOR CARRYING OUT THE INVENTION

Hereinafter, embodiments of the present invention will be described in detail with reference to the accompanying drawings. Note that the same components are denoted by the same reference symbols throughout all the drawings for describing the embodiments, and the repetitive description thereof will be omitted.

### First Embodiment

<Outline>

In a referring image and a moving image, respective feature points corresponding to each other are extracted as a pair. The position information of the feature-point pair is extracted from each of the referring image and the moving image, and the initial position of each control point on a control grid used for the registration processing is determined by using the extracted position information. In this manner, optimization calculation for obtaining the movement amount of each control point can be more accurately executed. As a result, a stable and accurate registration processing can be achieved.

<Configuration and Operation>

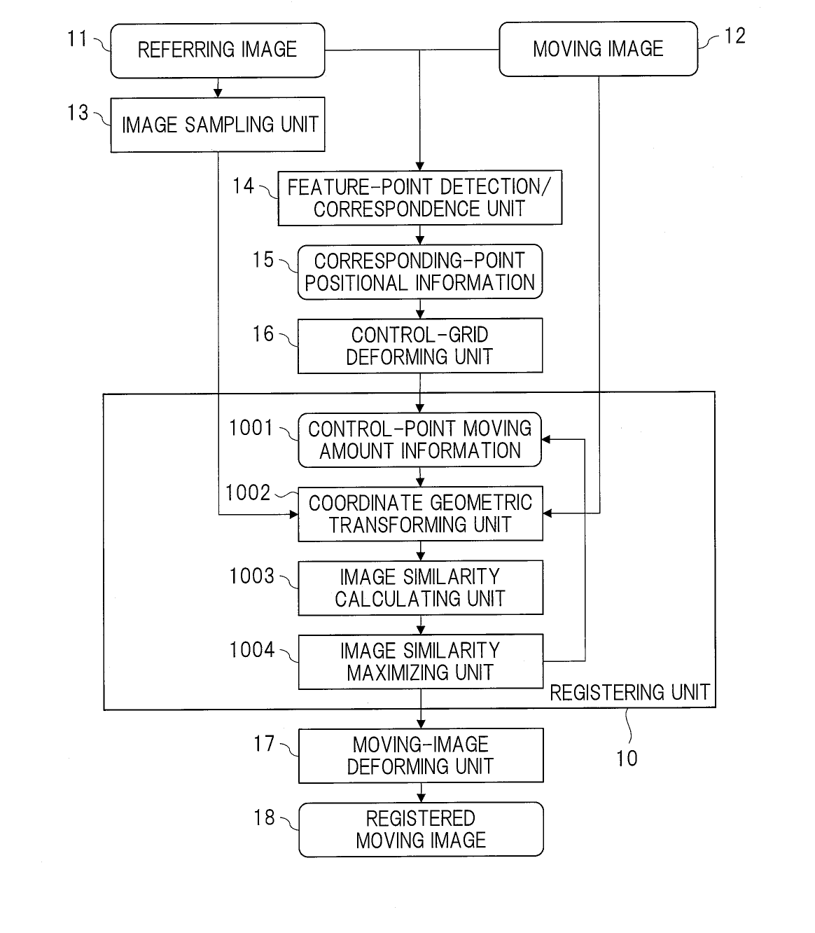

FIG. 1 is a block diagram illustrating a logical configuration of an image processing apparatus according to the first embodiment. In this drawing, a reference symbol “11” denotes the referring image, and a reference symbol “12” denotes the moving image. The moving image 12 is an image which is deformed in the execution of the registration as described above. The image processing apparatus registers the referring image 11 and the moving image 12. Each content of the referring image 11 and the moving image 12 is changed by an image to be registered. In order to facilitate the explanation, this drawing also illustrates the referring image 11 and the moving image 12. However, it should be understood that the image processing apparatus does not include the referring image and the moving image.

The image processing apparatus includes an image sampling unit 13, a feature-point detection/correspondence unit 14, a control grid deforming unit 16, a registering unit 10, and a moving-image deforming unit 17. In this drawing, note that a reference symbol “18” denotes a moving image whose registration has been completed by the image processing apparatus.

The feature-point detection/correspondence unit 14 receives each of the referring image 11 and the moving image 12, extracts the feature point from each of the images, and extracts a position corresponding to each of the extracted feature points from the referring image 11 and the moving image 12. The information of the extracted position is outputted as position information (hereinafter, also referred to as corresponding-point position information) 15 of a point corresponding to each of the extracted feature points. The control grid deforming unit 16 decides the initial positions of control points on the control grid by deforming the control grid using the corresponding-point position information 15 outputted from the feature-point detection/correspondence unit 14. The determined initial positions of the control points are fed to the registering unit 10.

The image sampling unit 13 receives the referring image 11, extracts image sampling points and sampling data of the referring image 11 used for calculation of image similarity, and feeds them to the registering unit 10. The registering unit 10 executes the registration in accordance with the image data and the control grid received from each unit, and feeds the registration result to the moving-image deforming unit 17. The moving-image deforming unit deforms the moving image 12 in accordance with the fed registration result, and outputs the deformation result as the registered moving image 18. These operations will be described in detail after a description of a hardware configuration of the image processing apparatus.

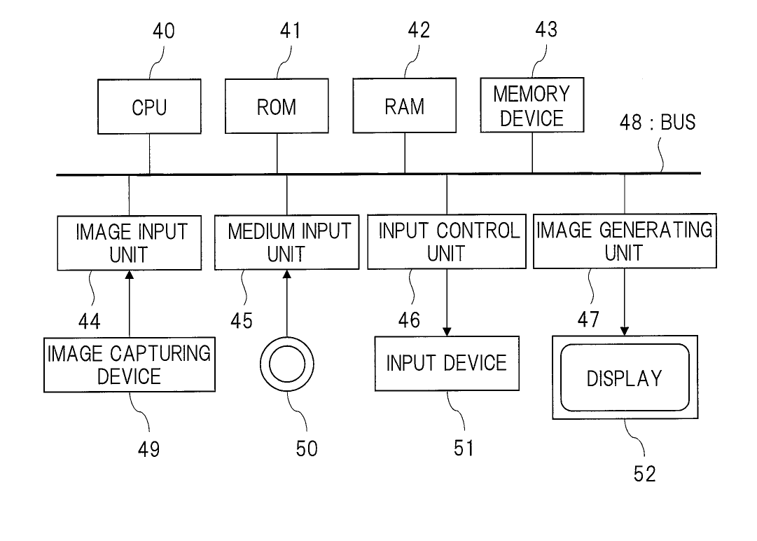

FIG. 2 is a block diagram illustrating the hardware configuration of the image processing apparatus according to the first embodiment. The hardware configuration illustrated in FIG. 2 is commonly used among a plurality of embodiments described later.

In addition, the image processing apparatus according to an embodiment can be implemented on a general computer and may be placed in a medical facility or the others. Alternatively, the image processing apparatus may be placed in a data center, and a result of the image registration may be transmitted to a client terminal via a network. In this case, an image to be registered may be fed from a client terminal to the image processing apparatus in the data center via the network. The following is explanation while exemplifying a case of the implementation of the image processing apparatus in the computer placed in the medical facility.

In FIG. 2, a reference symbol “40” denotes a CPU (processor), a reference symbol “41” denotes a ROM (nonvolatile memory: read-only storage medium), a reference symbol “42” denotes a RAM (volatile memory: data rewritable storage medium), a reference symbol “43” denotes a storage device, a reference symbol “44” denotes an image input unit, a reference symbol “45” denotes a medium input unit, a reference symbol “46” denotes an input control unit, and a reference symbol “47” denotes an image generating unit. The CPU 40, the ROM 41, the RAM 42, the storage device 43, the image input unit 44, the medium input unit 45, the input control unit 46, and the image generating unit 47 are connected to one another via a data bus 48. Although not specifically limited, the computer placed in the medical facility includes these devices.

The ROM 41 and the RAM 42 store a program and data which are required to achieve the image processing apparatus by the computer. The CPU 40 executes the program stored in the ROM 41 and the RAM 42, so that various types of processing in the image processing apparatus is achieved. The storage device 43 described above is a magnetic storage device which stores input images or others. The storage device 43 may include a nonvolatile semiconductor storage medium (e.g., a flash memory). In addition, an external storage device connected via a network may be used.

The program to be executed by the CPU 40 may be stored in a storage medium 50 (e.g., an optical disk), and the medium input unit 45 (e.g., an optical disk drive) may read and store the program in the RAM 42. Alternatively, the program may be stored in the storage device 43, and the program may be loaded from the storage device 43 into the RAM 42. Alternatively, the program may be previously stored in the ROM 41.

The image input unit 44 is an interface to which images captured by an image capturing device 49 are inputted. The CPU 40 executes various types of processing by using the images inputted from the image capturing device 49. The medium input unit 45 reads out data and a program stored in the storage medium 50. The data and the program read out from the storage medium 50 are stored in the RAM 42 or the storage device 43.

The input control unit 46 is an interface which receives an operation input inputted by a user from an input device 51 (e.g., a keyboard). The operation input received by the input control unit 46 is processed by the CPU 40. For example, the image generating unit 47 generates image data from the moving image 12 deformed by the moving-image deforming unit 17 illustrated in FIG. 1, and transmits the generated image data to a display 52. The display 52 displays the image on a screen.

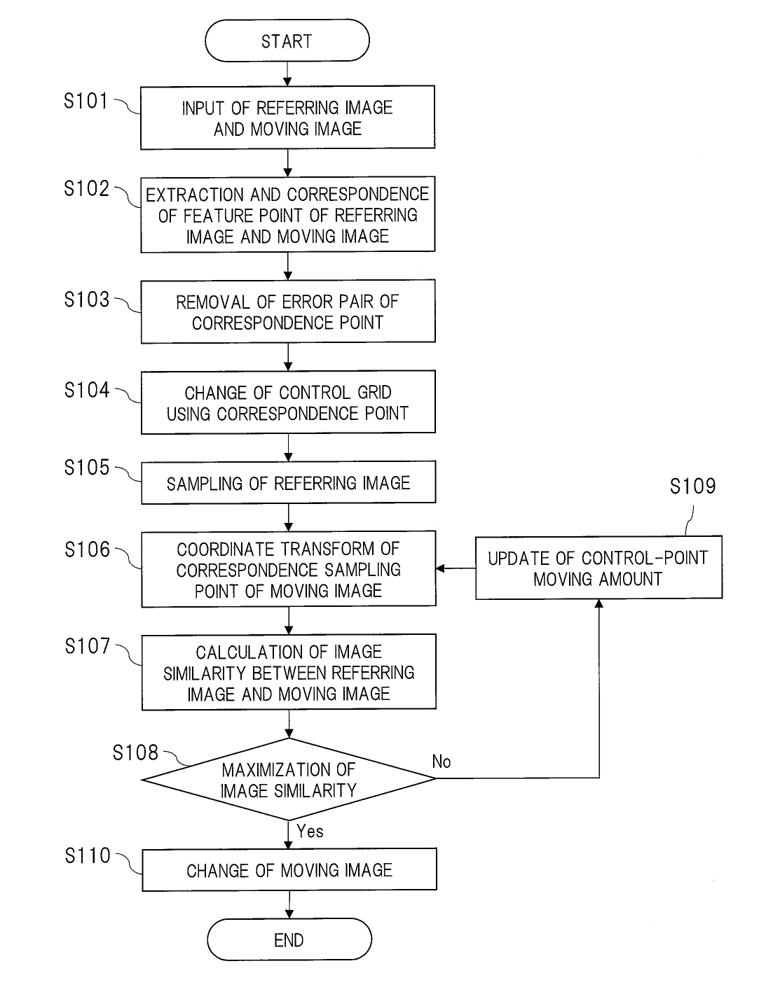

Next, the operation of the image processing apparatus according to the first embodiment will be described with reference to the image processing apparatus illustrated in FIG. 1 and the flowchart illustrated in FIG. 3. Here, FIG. 3 is a flowchart illustrating the operation of the image processing apparatus illustrated in FIG. 1.

The processing starts (“START” in FIG. 3), and each of the referring image 11 and the moving image 12 is inputted in step S101. In step S102, the feature-point detection/correspondence unit 14 extracts the image feature point from each image, and detects a pair of the feature points corresponding to each other. In step S102, a corresponding-point pair is further extracted based on the detected feature-point pair.

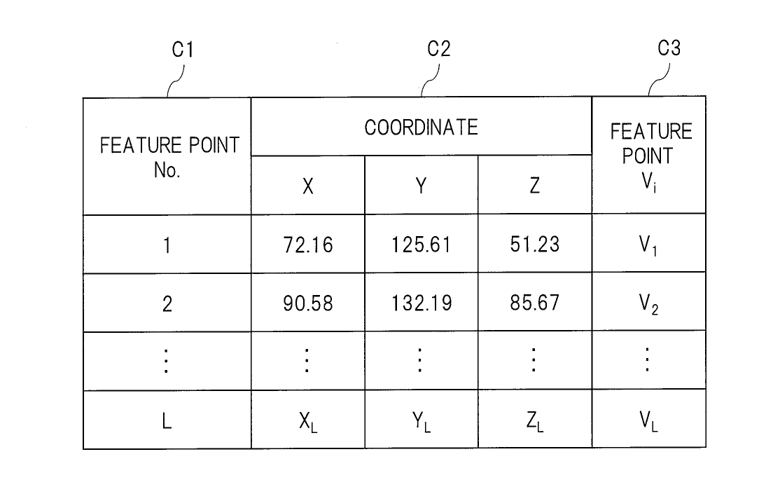

The feature point is provided to a feature image part on the image. Although the feature point will be described in detail later with reference to FIG. 4, each feature point has a feature amount. A feature amount distance is obtained between the feature point on the referring image and the feature point on the moving image. Two feature points whose feature amount distance obtained is the minimum are set as the feature points (the feature-point pair) corresponding to each other. That is, a pair of feature points having the minimum distance between their feature amounts is set as the feature-point pair. Based on the feature point on the referring image which configures the feature-point pair, a position corresponding to the feature point is extracted from the referring image. Similarly, based on the feature point on the moving image which configures the same feature-point pair, a position corresponding to the feature point is extracted from the moving image. The extracted positions are paired so as to correspond to the feature-point pair.

In step S102, a plurality of the feature-point pairs are extracted as described above. That is, a plurality of the corresponding-point pairs are extracted. The plurality of the extracted feature-point pairs includes a feature-point pair whose distance between the feature amounts is relatively large. Such a feature-point pair has low reliability, and therefore, is removed in step S103 as an error corresponding-point pair. The corresponding-point position information 15 from which the error corresponding-point pair is removed is created in step S103.

The control grid deforming unit 16 determines the initial position of the control point on the control grid by deforming the grid control using the corresponding-point position information 15 (step S104). The determined initial position is fed to the registering unit 10 as control-point moving amount information 1001 (FIG. 1). The image sampling unit 13 extracts an image sampling point and sampling data used for the image similarity calculation from the referring image 11 (step S105), and feeds them to the registering unit 10.

As illustrated in FIG. 1, the registering unit 10 described above includes a coordinate geometric transforming unit 1002, an image similarity calculating unit 1003, and an image similarity maximizing unit 1004. To the coordinate geometric transforming unit 1002 in the registering unit 10, the sampling point and the sampling data of the referring image 11, the moving image 12, and the control-point moving amount information 1001 are fed. The registering unit 10 transforms the coordinates of the moving image by using the control-point moving amount information 1001. Here, the coordinate of the moving image are transformed so that sampling data is acquired at a sampling point on the moving image 12 obtained so as to correspond to the sampling point on the referring image (step S106).

To the image similarity calculating unit 1003 (FIG. 1) in the registering unit 10, the sampling data on the referring image 11 and the sampling data on the moving image 12 which corresponds to the sampling point on the referring image 11 are fed. That is, the sampling data of the sampling points corresponding to each other is fed thereto. The image similarity calculating unit 1003 calculates the image similarity between the image samples (sampling data) of the referring image 11 and the moving image 12 which correspond to each other (step S107).

The image similarity maximizing unit 1004 (FIG. 1) operates so as to maximize the above-described image similarity. In step S108, it is determined whether the image similarity is maximized or not. If it is determined that the image similarity is not maximized, the control-point moving amount information 1001 is updated so as to maximize the image similarity (step S109), and steps S106, S107, and S108 are executed again. These processes are repeated until the image similarity is maximized.

On the other hand, if it is determined that the image similarity is maximized, the registering unit 10 outputs the control-point moving amount information 1001 obtained when the image similarity is maximized to the moving-image deforming unit 17. The moving-image deforming unit 17 executes geometric transformation of the moving image 12 by using the control-point moving amount information 1001, and generates and outputs the registered moving image 18 (step S110).

Each of these units will be described in more detail below.

<Feature-Point Detection/Correspondence Unit>

The feature-point detection/correspondence (corresponding-point setting) unit 14 detects the image feature point on each of the referring image 11 and the moving image 12, and records the feature amount of each feature point. An example of a recording form will be described with reference to FIG. 4.

FIG. 4 illustrates the data structure of the image feature points extracted by the feature-point detection/correspondence unit 14. In this drawing, the data structure obtained in the extraction taking a three-dimensional image as a target example is illustrated. In FIG. 4, the number of the feature point is shown in a column C1, the coordinates of the feature point are shown in a column C2, and a feature-amount vector Vᵢ, is shown in a column C3. In this drawing, the feature points are 1 to L, and three-dimensional coordinates of each of them are represented by x-, y-, and z-coordinates. In addition, the feature-amount vectors Vᵢ of the respective feature points are shown as V₁ to V_{L}. For example, with regard to a feature point 1, its three-dimensional coordinates are (x-coordinate: 72.16, y-coordinate: 125.61, and z-coordinate: 51.23), and its feature-amount vector is V.

As a method of detecting the image feature point and a method of describing the feature amount, a publicly-known method can be used. As the publicly-known method, for example, SIFT (Scale-Invariant Feature Transform) feature point detection and SIFT feature amount description can be used. In this embodiment, since the image to be registered is a three-dimensional image, the image feature point detection and feature amount description methods are extended from the two to three dimension.

Next, the feature-point detection/correspondence unit 14 then searches the feature point on the moving image 12 which corresponds to the feature point on the referring image 11. In specific explanation, when the feature amounts (feature-amount vectors) of a feature point P^{r} on the referring image 11 and a feature point P^{f} on the moving image 12 are set to “V^{r}” and “V^{f}”, an inter-feature amount Euclidean distance “d” is calculated by Expression (1). Here, “M” represents the dimension of the feature amount.

$$\begin{matrix}[ Expression 1 ] & \\ d ( {V}^{r} , {V}^{f} ) = \sqrt{{\sum }_{i = 1}^{M} {( {v}_{i}^{r} - {v}_{i}^{f} )}^{2}} & Expression 1\end{matrix}$$

The feature-point detection/correspondence unit 14 calculates the distances “d” between the feature amount of a certain one feature point in the referring image 11 and the feature amounts of all the feature points included in the moving image 12, and detects the feature points having the smallest distance “d” therebetween among the feature points as (paired) points corresponding to each other.

It can be determined that a pair of feature points having the large inter-feature amount distance “d” therebetween has low reliability, and therefore, the feature-point detection/correspondence unit 14 performs the processing of removing such a feature-point pair having the low reliability as an error corresponding-point pair in step S103 (FIG. 3). Although not particularly limited, the removing process of the error corresponding-point pair is executed in two steps. First of all, the feature-point pair having the distance exceeding an experimentally-set threshold is removed as the error corresponding pair from targets for the subsequent processing. In addition, for the remaining feature-point pairs, the error corresponding pair is robustly removed by using, for example, the RANSAC (Random Sample Consensus) method which is a publicly-known method. The feature-point detection/correspondence unit 14 outputs the position information of the feature-point pairs (corresponding-point pairs) obtained as described above to the control grid deforming unit 16 as the corresponding-point position information 15.

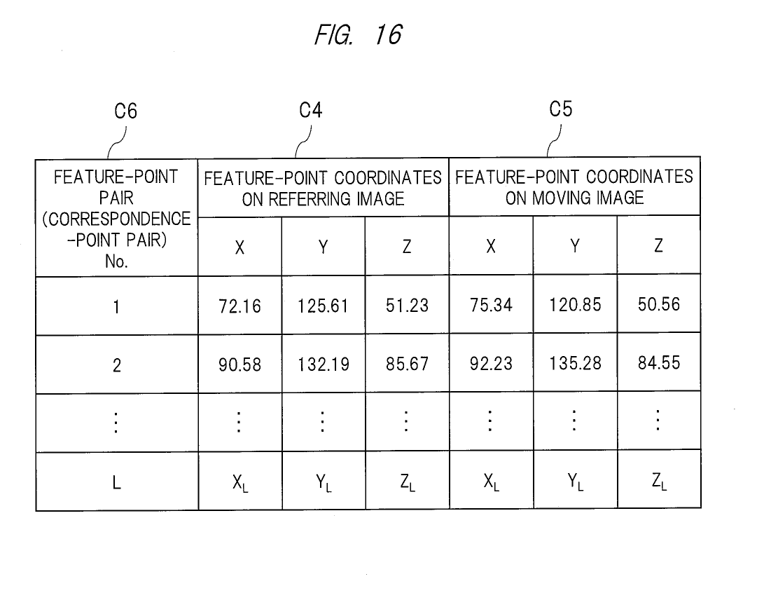

FIG. 16 illustrates an example of the data structure of the corresponding-point pairs. In this drawing, a column C6 indicates the number of the feature-point pair, a column C4 indicates the coordinates (position) of the feature point on the referring image, and a column C5 indicates the coordinates of the feature point on the moving image. As similar to the illustration in FIG. 4, a case of the acquisition of the feature points from the three-dimensional referring image and the three-dimensional moving image as targets is illustrated in FIG. 16.

As different from FIG. 4, in FIG. 16, the feature amount is not included in the data structure. This is because it is found out that the feature points correspond to each other, and therefore, the feature amount is not particularly included in the data structure. In addition, FIG. 16 illustrates the points corresponding to each other, and therefore, it can be understood that the number described in the column C6 is the number of the corresponding-point pair. As similar to FIG. 4, FIG. 16 illustrates the feature points (corresponding-point pairs) from 1 to L, and illustrates the respective positions on the referring image and the moving image in the form of three-dimensional coordinates. That is, FIG. 16 illustrates the number of the corresponding point pair and the positions of feature points configuring the corresponding-point pair represented by the number in the referring image and the moving image. For example, the corresponding-point pair whose number is represented by 1 is configured by a feature point on the referring image whose position is indicated by three-dimensional coordinates (x-coordinate: 72.16, y-coordinate: 125.61, and z-coordinate: 51.23) and a feature point on the moving image whose position is indicated by three-dimensional coordinates (x-coordinate: 75.34, y-coordinate: 120.85, and z-coordinate: 50.56).

The corresponding-point position information 15 outputted to the control grid deforming unit 16 includes the information of the corresponding point (feature-point) pair illustrated in FIG. 16.

In the feature-point detection/correspondence unit 14 edit (including addition and deletion) of the corresponding-point pair is possible. For example, the information of the corresponding-point pair illustrated in FIG. 16 can be edited by using the input device 51 illustrated in FIG. 1. For example, by editing the corresponding-point pair by using empirical knowledge, the registration accuracy can be improved.

<Control Grid Deforming Unit>

The control grid deforming unit 16 deforms a control grid used for the registration processing by using the corresponding-point position information 15 (as initial position setting). Although not particularly limited, in the control grid deforming unit 16, the control grid which is used for the deformation of the moving image 12 is arranged on the moving image 12 (as control point setting). While regarding the grid-pattern control points on the control grid arranged on the moving image 12 as a vertex of a three-dimensional mesh, the control point mesh is deformed by using a geometrical distance between the above-described corresponding points. Here, a publicly-known method such as the MLS (Moving Least Squares) method can be used. In the MLS method, for a certain vertex in the control mesh, a control point which is the vertex (the above-described certain vertex) is moved so as to simulate the movement of the feature point on the moving image 12 which is close to the vertex as much as possible (simulate the shift toward the corresponding point on the referring image 11). Therefore, the control grid deforming unit 16 obtains such non-rigid deformation of the control mesh as flexibly matching with the movement of a surrounding corresponding point (step S104). The control grid deforming unit 16 (FIG. 1) acquires the control-point moving amount information 1001 from the deformed control grid, and outputs the information to the registering unit 10.

<Image Sampling Unit>

The image sampling unit 13 (FIG. 1) extracts image sampling points and sampling data from the referring image 11, and outputs them to the registering unit 10. These image samples are used for the calculation of the image similarity in the registration processing.

The sampling may be performed while taking all the pixels in the image region which is the target of the registration processing as the sampling points. However, in order to increase the speed of the registration processing, a grid may be placed on the image, and only pixels at nodes of the grid may be used as the sampling points. Alternatively, in a sampling target region, the predetermined number of coordinates may be randomly generated, and luminance values at the obtained coordinates maybe used as luminance values at the sampling points. In a medical image processing apparatus, it is desired to use the luminance values as the sampling data for improving the processing speed. However, the sampling data may be color information in accordance with the intended use of the image processing apparatus.

<Registering Unit>

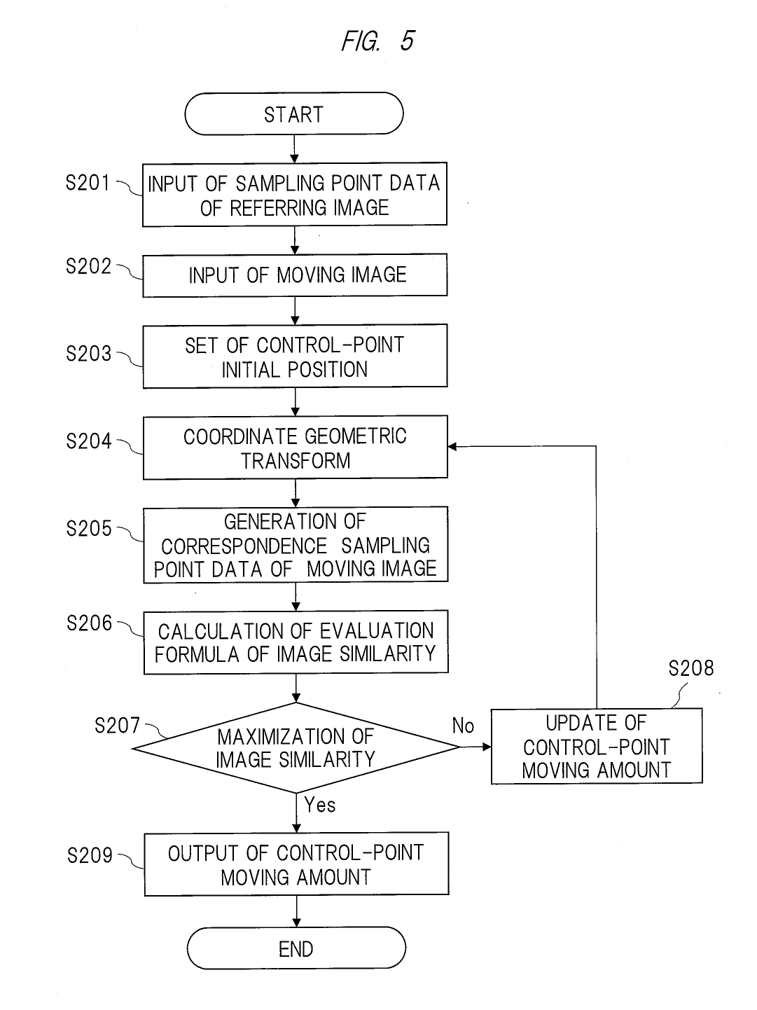

As described above, the registering unit 10 (FIG. 1) includes the coordinate geometric transforming unit 1002, the image similarity calculating unit 1003, and the image similarity maximizing unit 1004. The operation of each of these functional units will be described next with reference to FIG. 5. FIG. 5 is a flowchart for explaining the processing performed by the registering unit 10.

The coordinate geometric transforming unit 1002 (FIG. 1) acquires the sampling data of the referring image 11 and the moving image 12 (steps S201 and S202). In addition, the coordinate geometric transforming unit 1002 arranges a control grid on the acquired moving image 12, acquires the control-point moving amount information 1001 (FIG. 1) from the control grid deforming unit 16 (FIG. 1), and sets the initial positions of control points on the above-described control grid based on the control-point moving amount information 1001 (step S203).

In addition, the coordinate geometric transforming unit 1002 executes the coordinate transformation of the coordinates of the sampling points on the referring image 11 by using the control-point moving amount information 1001 (step S204). This step aims at calculating the coordinates of the image data on the moving image 12 which correspond to the coordinates of the sampling points on the referring image 11. Here, based on the positions of control points in periphery of the coordinates of a certain sampling point, the coordinates of the sampling point is interpolated by using, for example, a publicly-known B-spline function, so that the coordinates of the corresponding sampling point on the moving image 12 is calculated.

Next, the coordinate geometric transforming unit 1002 calculates a luminance value at the corresponding sampling point on the moving image 12 (a sampling point corresponding to each sampling point on the referring image 11) by, for example, linear interpolation computation (step S205: extraction). This manner obtains the moving-image coordinates (sampling point) changed by the movement of the control point and obtains the luminance value at the coordinates (sampling point). That is, the moving image is deformed by the movement of the control point in the coordinate geometric transforming unit 1002.

The image similarity calculating unit 1003 (FIG. 1) acquires the data (sampling data) at sampling points on the referring image 11 and the data (data generated in step 5205) at corresponding sampling points on the moving image 12 obtained after the geometric transformation. The image similarity calculating unit 1003 computes the image similarity between the referring image 11 and the moving image 12 by applying a predetermined evaluation function to the data at these sampling points (step S206). As the image similarity, a publicly-known mutual information content can be used.

The image similarity maximizing unit 1004 (FIG. 1) acquires the image similarity between the referring image 11 and the moving image 12 based on the calculation by the image similarity calculating unit 1003. Here, convergence calculation is executed in order to obtain such a movement amount of each control point as maximizing (or most increasing) the image similarity between the referring image 11 and the moving image 12 (step S207). If the image similarity does not converge in step S207, the image similarity maximizing unit 1004 updates the control-point moving amount information 1001 in order to obtain a higher image similarity (step S208). Then, the steps S204 to S207 are executed again by using the updated control-point moving amount information 1001.

On the other hand, if the image similarity converges in step S207, the registering unit 10 outputs the obtained control-point moving amount information 1001 to the moving-image deforming unit 17 (step S209). Through the above-described processing, the processing performed by the registering unit 10 is completed.

<Moving-Image Deforming Unit>

The moving-image deforming unit 17 (FIG. 1) acquires the moving image 12 and the control-point moving amount information 1001. The moving-image deforming unit 17 calculates the coordinates of each of all the pixels of the moving image 12 by the interpolation computation based on the control-point moving amount information 1001 as similar to that in step S204. Next, the moving-image deforming unit 17 generates the registered moving image 18 by calculating the luminance at the obtained coordinates by the interpolation computation as similar to that in step S205.

According to this embodiment, the respective positions on the referring image and the moving image are obtained from the feature-point pair (corresponding-point pairs) corresponding to each other. By using the obtained position, the initial value (position) of the control point to be used for the registration between the referring image and the moving image is set. In this manner, the initial value of the control grid can be set to more appropriate value, so that the registration accuracy can be improved. In addition, the time required for the registration can be shortened.

<Application Example>

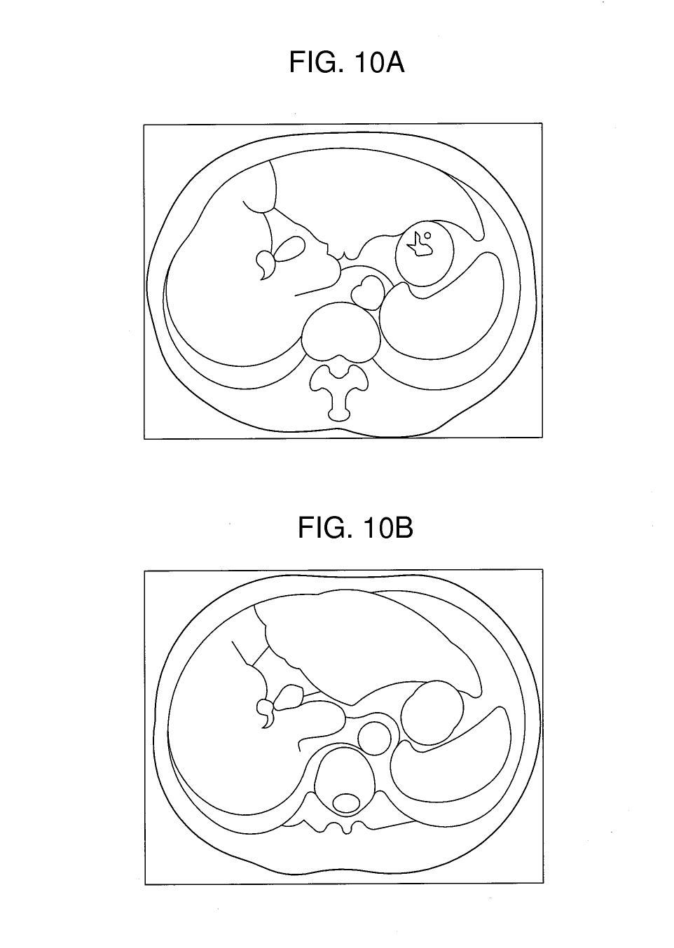

Next, an example of application to a medical image will be described with reference to FIGS. 10 to 15. The following is the explanation exemplifying a transverse plane slice of an abdominal region of a human body. However, in order to prevent the drawings for the explanation from being complicated, the explanation will be made by using schematic views of a transverse plane slice of an abdominal region of a human body.

FIGS. 10(A) and (B) are schematic views of the transverse plane slice of the abdominal region of the human body. In each of FIGS. 10(A) and (B), an upper side corresponds to a front side of the human body, and a lower side corresponds to a back side of the human body. In each of FIGS. 10(A) and 10(B), a backbone portion is on the lower side of the center, a liver portion is on the left side of the center, and a spleen portion is on the right side of the center. In addition, a pancreas portion and a large blood vessel are on the center and the upper side of the center.

Although not particularly limited, the transverse plane slice of the abdominal region illustrated in FIG. 10(A) is a transverse plane slice of an abdominal region obtained before medical treatment, and the transverse plane slice of the abdominal region illustrated in FIGS. 10(B) is the transverse plane slice of the abdominal region obtained after the medical treatment. Therefore, the positions of the organs and others and/or the shapes thereof on the transverse plane slice of the abdominal region are different between FIG. 10(A) and FIG. 10(B). In such description as following the embodiment described above, an effect of the medical treatment can be checked by registering the images of these two transverse plane slices of the abdominal region. One of the images of the transverse plane slices of the abdominal region illustrated in FIGS. 10(A) and 10(B) is set as the referring image, and the other is set as the moving image. Although not particularly limited, this embodiment will be described while exemplifying a case of the image illustrated in FIG. 10(A) (i.e., the image related to the transverse plane slice of the abdominal region obtained before the medical treatment) as the referring image and the image illustrated in FIG. 10(B) (i.e., the image related to the transverse plane slice of the abdominal region obtained after the medical treatment) as the moving image.

The images illustrated in FIGS. 10(A) and 10(b) (the images related to the transverse plane slice of the abdominal region) are inputted as the referring image and the moving image in step S101 (FIG. 3). From the input images, feature portions (regions) of the images are extracted as the feature points, and are corresponded to each other (step S102 in FIG. 3). Here, since the input images are medical images, for example, a featured shape or blood vessel portion in the organ is handled as the feature region. The feature region is found out from each of FIGS. 10(A) and 10(B), and the feature points are extracted and corresponded to each other.

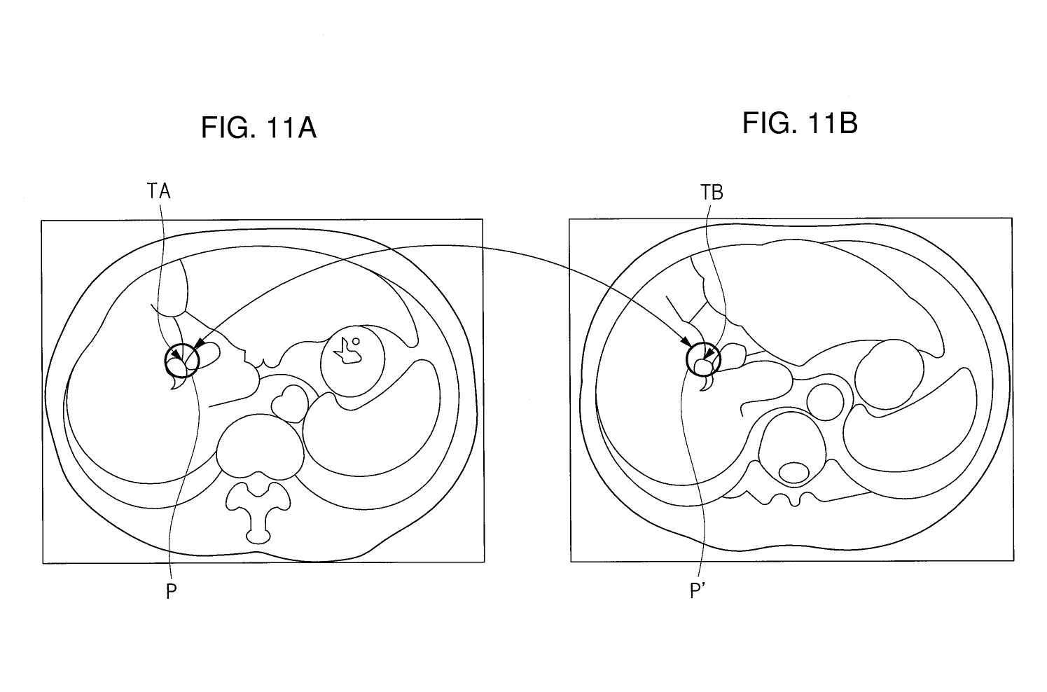

FIGS. 11(A) and 11(B) illustrate transverse plane slices of an abdominal region of a human body obtained by finding out the feature regions from the images illustrated in FIGS. 10(A) and 10(B) (the images related to the transverse plane slices of the abdominal region), extracting the feature points, and corresponding them to each other. Here, FIG. 11(A) illustrates the same transverse plane slice of the abdominal region as that illustrated in FIG. 10(A), and FIG. 11(B) illustrates the same transverse plane slice of the abdominal region as that illustrated in FIG. 10(B). In each of FIGS. 11(A) and 11(B), the feature region in the organ is found out as the feature portion of the organ although not specifically limited. This feature region is extracted as the feature point. In FIGS. 11(A) and 11(B), these feature regions are represented by a symbol “TA” (FIG. 11(A)) and a symbol “TB” (FIG. 11(B)), respectively.

The respective feature regions TA and TB in FIGS. 11(A) and 11(B) are extracted as feature points “P” and “P′”. The extracted feature point has coordinates (x, y, z) and a feature amount vector (Vᵢ) as illustrated in FIG. 4. Here, the coordinates are coordinates of a feature region “T” in the image. In FIGS. 11(A) and 11(B), note that sizes of circular marks at the illustrated positions are different between the feature region TA (TB) and a corresponding feature point P (P′). However, the sizes are changed only to make each drawing easily see, and therefore, have no meaning.

The transverse plane slices of the abdominal region illustrated in FIGS. 11(A) and 11(B) have not only the above-described feature regions TA and TB but also many feature regions showing the features of the organs. However, the many feature regions are omitted in FIGS. 11(A) and 11(B) in order to prevent the drawings from being complicated. Feature regions not illustrated are also extracted as the feature points. As described in steps S102 and S103 in FIG. 3, the feature points corresponding to each other are extracted as the feature-point pair (corresponding-point pair) by using the feature amount vectors Vᵢ of the respective feature points. FIGS. 11(A) and 11(B) illustrate the feature points P and P′ which correspond to the feature regions TA and TB among a plurality of feature points and a plurality of corresponding-point pairs configured by the feature points. It is assumed that the feature points P and P′ have been determined to be paired by computation using the feature amount vectors. That is, the feature points P and P′ configure the feature-point pair (corresponding-point pair).

As illustrated in FIG. 16, the feature point pair “P and P′” is registered as data. That is, in the feature point pair P and P′, the coordinates of the region TA corresponding to the feature point P which is the feature point on the referring image and the coordinates of the region TB corresponding to the feature point P′ which is the feature point on the moving image are registered in the data structure illustrated in FIG. 16. At this time, the number of the feature-point pair (corresponding-point pair) is also provided as, for example, “P”. Obviously, feature-point pairs other than the feature-point pair configured by the feature points P and P′ are also registered in the data structure illustrated in FIG. 16 in the same manner. The information of the corresponding-point pair illustrated in FIG. 16 is included in the corresponding-point position information 15, and is fed to step 5104 (FIG. 3) of deforming the control grid using the corresponding points.

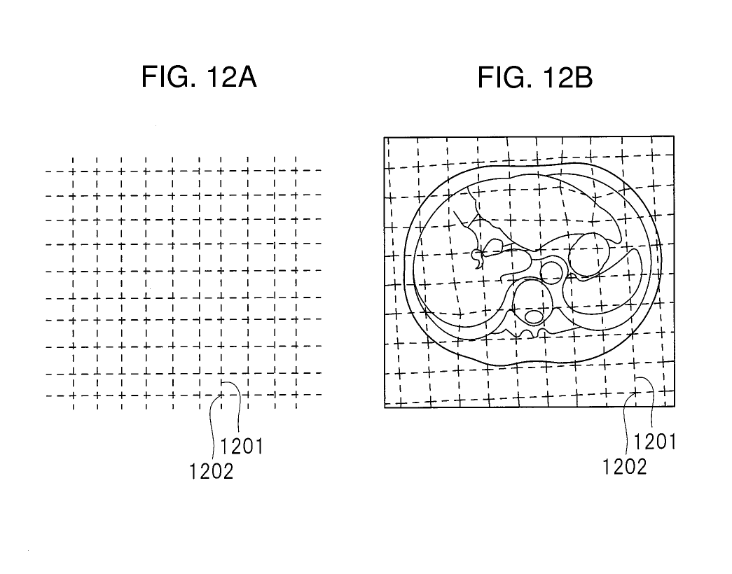

FIG. 12(A) is a diagram of a control grid 1201 arranged on the moving image. The control grid 1201 includes a plurality of control lines (dashed lines) and a plurality of control grid points (control points) 1202 which are the intersection points between the control lines, which are arranged vertically and horizontally, respectively. The control grid is arranged on the moving image. Although not particularly limited, the intervals between the control grid points obtained before the arrangement are set to be equal to each other in the vertical and horizontal directions.

The control grid 1201 has been described in the description of the control grid deforming unit 16, and can deform the moving image by deforming the control grid. That is, in this embodiment, as illustrated in FIG. 11(B), the control grid 1201 is arranged on an image of the transverse plane slice of the abdominal region, and the control grid 1201 is deformed, so that the image of the transverse plane slice of the abdominal region which is the moving image is deformed. In this embodiment, the position of the control point 1202 of the control grid 1201 arranged on the moving image (the image of the transverse plane slice of the abdominal region) is moved based on the corresponding-point position information 15 (FIG. 1) in the control grid deforming unit 16 (FIG. 1), so that the control grid 1201 is deformed. That is, the position of the control point 1202 is initially set based on the corresponding-point position information 15. In other words, the control grid 1201 is previously deformed (initially set) based on the corresponding-point position information 15.

FIG. 12(B) is a schematic view illustrating an image of the transverse plane slice of the abdominal region on which the control grid 1201 after the initial setting is arranged and whose image is deformed. That is, FIG. 12(B) illustrates the image obtained after the arrangement of the control grid 1201 illustrated in FIG. 12(A) on the image of the transverse plane slice of the abdominal region illustrated in FIG. 11(B) and the initial setting of the control grid 1201 based on the corresponding-point position information 15. In the case illustrated in FIG. 12(B), the control grid 1201 is deformed so as to be entirely deformed toward the upper right and so as to have a deformed control grid portion on the upper right portion. By the initial setting, the position of the control point 1202 is moved, and the control grid 1201 is deformed, so that the moving image is also deformed.

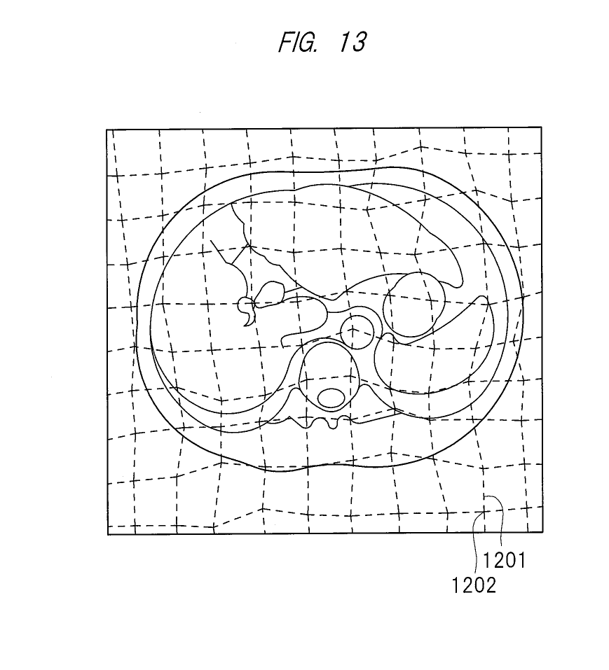

After the initial setting of the control grid 1201, the control grid 1201 is further deformed so as to maximize the image similarity between the referring image (e.g., FIG. 11(A)) and the moving image by the coordinate geometric transforming unit 1002 (FIG. 1), the image similarity calculating unit 1003 (FIG. 1), and the image similarity maximizing unit 1004 (FIG. 1). FIG. 13 illustrates an example of the moving image and the control grid 1201 in this further deformation process. In comparison between FIG. 12(B) and FIG. 13 in the deformation process, the control grid 1201 is further deformed so that, for example in FIG. 13, each grid is deformed from a square in FIG. 12(B) in order to maximize the image similarity. In this manner, the image similarity is maximized.

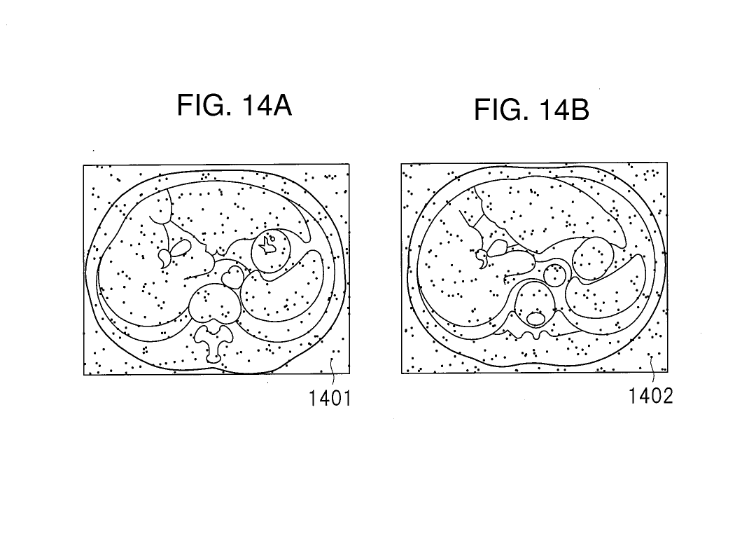

In the process of the similarity maximization, the coordinate geometric transforming unit 1002 (FIG. 1) acquires sampling points on the images and sampling data at the points. FIGS. 14(A) and 14(B) illustrate images of a transverse plane slice of an abdominal region obtained by representing the sampling points as a plurality of points 1401 and 1402 on the images. FIG. 14(A) illustrates the referring image. FIG. 14(B) schematically illustrates the sampling point 1402 on the moving image in the above-described deformation process. In this embodiment, a sampling point on the moving image in the deformation process and sampling data at the point are obtained by computation using the coordinate transformation, the interpolation, and others. In the image similarity calculating unit 1003, the obtained sampling point and the sampling data at the sampling point are used for the calculation of the similarity.

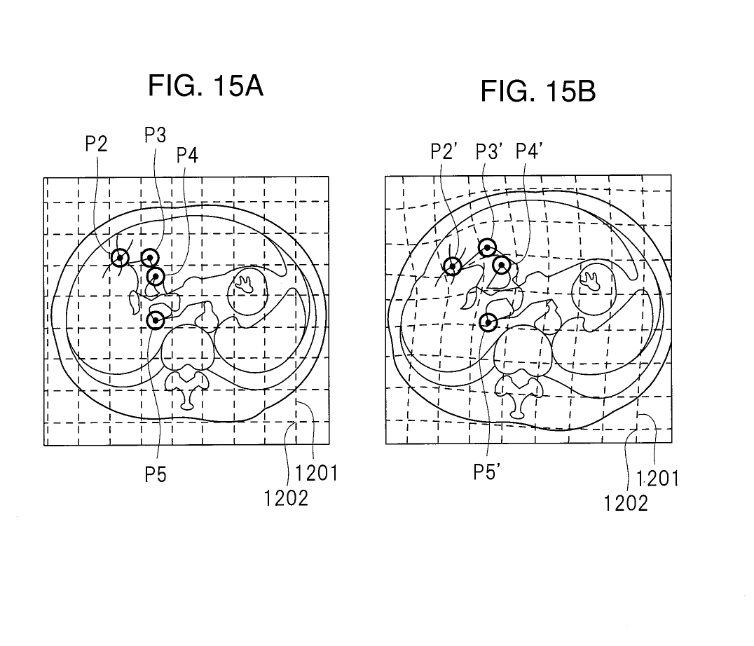

FIGS. 15(A) and 15(B) are views illustrating the images of the transverse plane slice of the abdominal region on each of which the control grid 1201 is arranged. FIG. 15(A) illustrates a transverse plane slice of the abdominal region which is similar to the transverse plane slice of the abdominal region illustrated in FIG. 11(B). As the feature points which are the feature points on this transverse plane slice of the abdominal region, feature points P2 to P5 are exemplified. In this example, the feature point P2 is extracted as a feature point so that a region where two blood vessels are as intersecting each other is as the feature region, and each of the feature points P3 to P5 is extracted as the feature point from the feature region of the organ. In order to explain the deformation of the moving image by deforming the control grid 1201, FIG. 15(A) illustrates a case in which the control grid arranged on the image has a square shape.

The feature points P2 to P5 correspond to feature points P2′ to P5′, respectively. The corresponding-point position information 15 is obtained from the above-described corresponding-point pairs. The control grid deforming unit 16 deforms the control grid 1201 based on the above-described corresponding-point position information 15. The control grid 1201 in FIG. 15(B) is the control grid obtained after the deformation. The moving image in FIG. 15(B) is the image obtained before the deformation. The registration accuracy can be improved by deforming the moving image by using the deformed control grid 1201 in FIG. 15(B), i.e., the initial values of the control points which have been more appropriately set.

Even after the execution of the initial setting for the control grid 1201, the control grid 1201 is deformed in the registering unit 10 (FIG. 1). At this time, the control grid is deformed based on the comparison between the sampling data on the referring image and the sampling data at the corresponding sampling point extracted from the moving image. That is, the control grid 1201 is deformed so as to maximize the similarity between the referring image and the moving image, so that the moving image is deformed.

### Second Embodiment

<Outline>

The regions to be registered are extracted from the referring image 11 and the moving image 12, respectively. In the extracted regions, the feature points and the corresponding-point pair are extracted. By using the position information of the corresponding-point pair, the control grid used for the registration processing is deformed. In this manner, the registration can be performed at a highspeed in a region (interest region) which is an interest of a person who uses the image processing apparatus. In addition, the position information of the corresponding points extracted from the above-described region is also used for optimization calculation in the registration processing. In this manner, the optimization calculation can converge more accurately at a higher speed.

<Configuration and Operation>

In the second embodiment, the control grid is deformed by using the corresponding-point pair extracted from a predetermined region which is the registration target, and the deformed control grid is used for the registration processing. The above-described predetermined region is designated as, for example, the region (interest region) which is the interest of the image processing apparatus is interested. In addition, the image sampling point used for the registration processing is also extracted from the interest region. Furthermore, the position information of the extracted corresponding-point pair is used for the calculation of the image similarity. In this manner, the accuracy and robustness of the registration in the interest region can be further improved. The following is the explanation mainly about the differences from the first embodiment. Therefore, the same reference symbol between the first embodiment and the present embodiment basically denotes the same component as that of the first embodiment, and a detailed description of the component will be omitted.

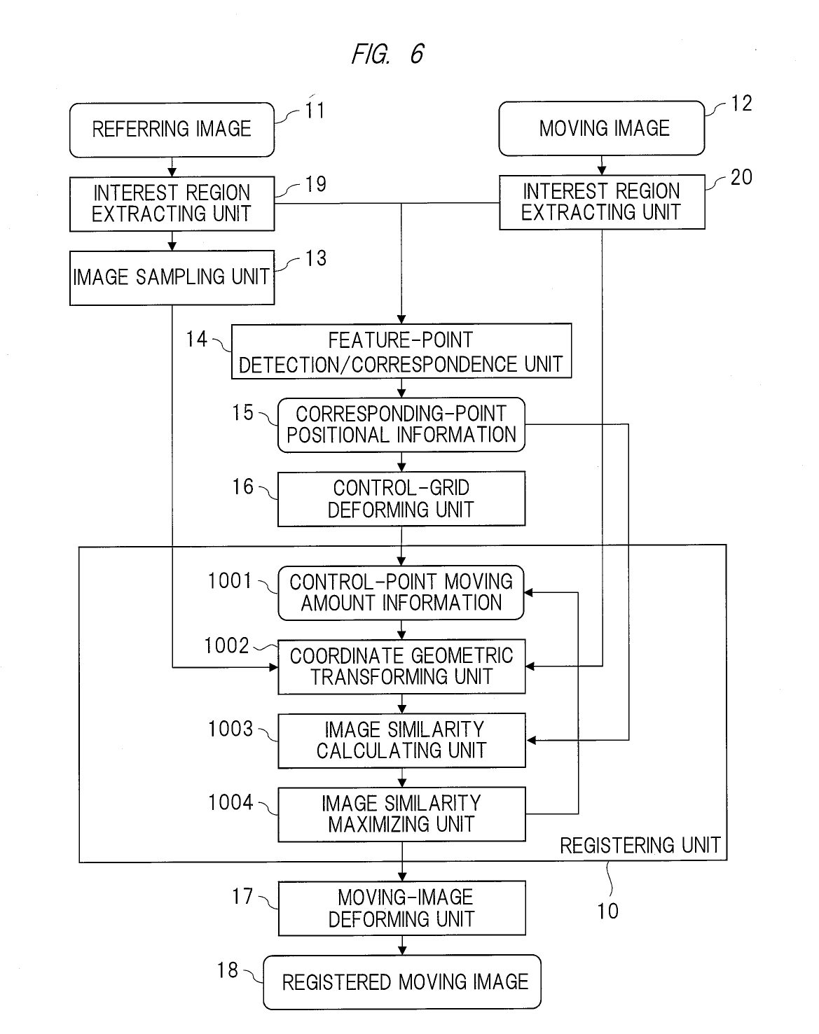

FIG. 6 is a functional block diagram of an image processing apparatus according to the second embodiment. In addition to the components described in the first embodiment, an interest region extracting unit 19 and an interest region extracting unit 20 which execute the extraction processing of the respective interest regions from the referring image 11 and the moving image 12 are added to a preceding stage of the image sampling unit 13 and the feature-point detection/correspondence unit 14. Other configurations are the same as those in the first embodiment. The respective functional units of the interest region extracting unit 19 and the interest region extracting unit 20 can be configured by using hardware such as circuit devices which achieve these functions. Alternatively, the respective functions provided in the interest region extracting unit 19 and the interest region extracting unit 20 may be configured by execution of programs on which these functions are installed in a computation device such as a CPU.

From each of the referring image 11 and the moving image 12, each of the interest region extracting units 19 and 20 extracts a region to be the registration target such as an image region corresponding to an organ or a tubular region included in the organ. The target region is specified by, for example, a user who uses the image processing apparatus.

As a method of the extraction of the organ region from each of the referring image 11 and the moving image 12, for example, a publicly-known graph cut method can be used. In the graph cut method, a region division problem is regarded as energy minimization, and the method is a method of obtaining a region boundary by using an algorithm for cutting a graph created from an image so that energy defined in the graph is minimized. In addition to the graph cut method, a region growing method, a method such as a threshold processing, or others can be also used.

The interest region extracting units 19 and 20 can also extract not the overall organ but a tubular region from the extracted organ regions. The tubular region is a region corresponding to a blood vessel portion when, for example, the organ is a liver, or corresponding to a bronchial portion when the organ is a lung. The following is explanation about a processing of an image region having the liver as a region of the registration target. That is, the interest region extracting units 19 and 20 divides the liver region from each of the referring image 11 and the moving image 12, and extract the image region including the liver blood vessel.

It is desired to use an anatomically-featured image data for the region of the registration target. As the image region having the feature image data in the liver region, an image region including the liver blood vessel and its surrounding region (a hepatic parenchymal region adjacent to the blood vessel) is conceivable. That is, the processing contents of the interest region extracting units 19 and 20 are to not extract only the liver blood vessel region but simultaneously extract the liver blood vessel and the hepatic parenchymal region adjacent to the blood vessel. Therefore, a processing such as accurate region division is not required.

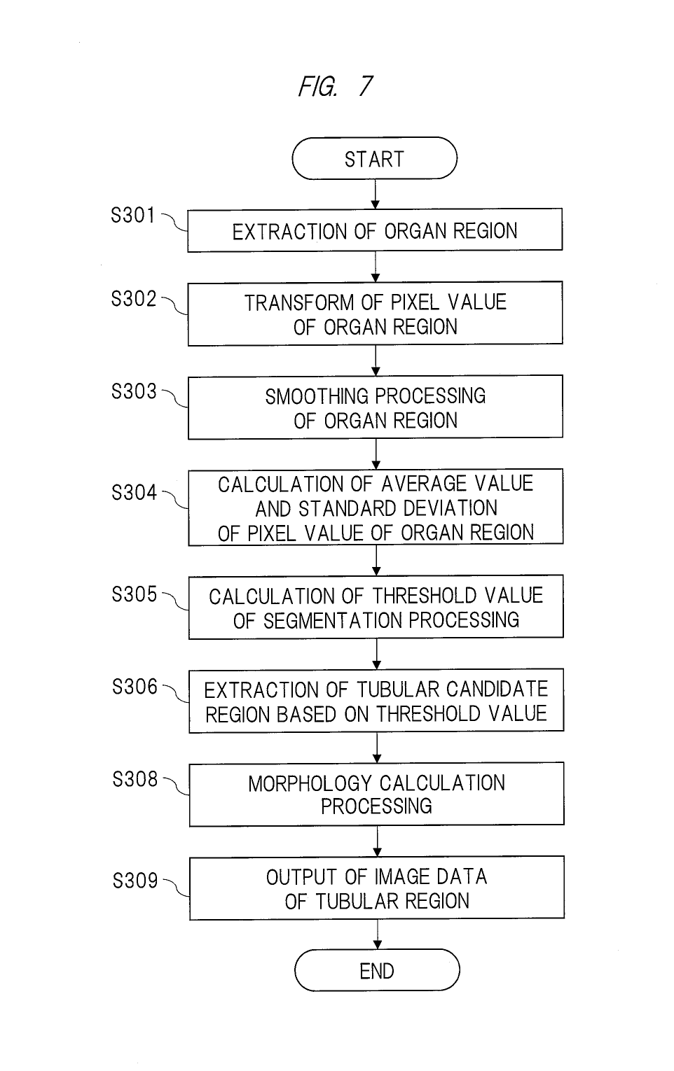

FIG. 7 is a flowchart illustrating each processes performed by the interest region extracting units 19 and 20. The processing of extracting the liver blood vessel and an adjacent region to the liver blood vessel will be described below with reference to FIG. 7.

The interest region extracting units 19 and 20 extract the image regions including the liver region from the referring image 11 and the moving image 12, respectively (step S301). The pixel value of the extracted liver region image is converted within a predetermined range in accordance with Expression (2) (step S302). For example, the pixel value is converted within a range of 0 to 200 HU (Hounsfield Unit: the unit for a CT value). Here, I(x) and I′(x) in Expression (2) represent pixel values obtained before and after the conversion, respectively, and Imin and Imax represent the minimum value, e.g., 0 (HU) and the maximum value, e.g., 200 (HU), respectively, in the conversion range.

$$\begin{matrix}[ Expression 2 ] & \\ {I}^{′} ( x ) = \{ \begin{matrix}0 , & I ( x ) \leq {I}_{min} \\ I ( x ) - {I}_{min} , & {I}_{min} < I ( x ) < {I}_{max} \\ {I}_{max} - {I}_{min} , & I ( x ) \geq {I}_{max}\end{matrix} & Expression ( 2 )\end{matrix}$$

Next, a smoothing processing is performed for the liver region image by using, for example, a Gaussian filter (step S303). Subsequently, an average value “μ” and a standard deviation “σ” of the pixel value of the smoothed liver region image are calculated (step S304). Next, in step S305, a threshold for the division processing is calculated. This calculation is performed by using, for example, Expression (3) to calculate a threshold “T”.

[Expression 3]

T=μ+1.0×σ Expression (3)

A threshold processing is performed for the pixel value of the data representing the liver region image by using the acquired threshold T (step S306). That is, the pixel value of each pixel is compared with the threshold T to extract a pixel having a pixel value larger than the threshold T as a pixel in an image region which is a blood vessel region candidate. Lastly, in step S307, a Morphology computation processing such as a dilation processing or an erosion processing is performed for the obtained image region. By this computation processing, a processing such as removal of an isolated pixel or connection between discontinuous pixels is performed. By the processing as described above, the liver blood vessel region to be a candidate region (target region) for the registration sampling processing and the feature-point extraction processing is extracted. The liver blood vessel region extracted from each of the referring image 11 and the moving image 12 is outputted to the image sampling unit 13 (FIG. 6) and the feature-point detection/correspondence unit 14 (FIG. 6) (step S308).

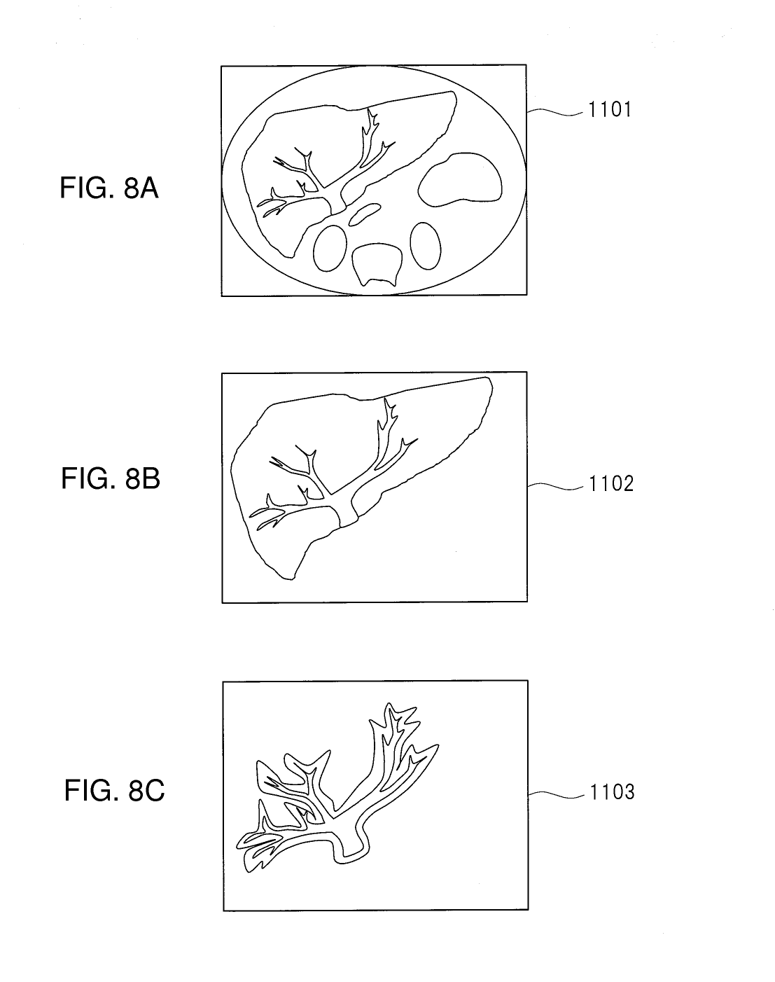

FIGS. 8(A) to 8(C) are views each illustrating an example of each image processed by the image processing apparatus according to the second embodiment. FIG. 8(A) illustrates a transverse plane of an abdominal region of a human body. That is, FIG. 8(A) illustrates the image including the liver and other organs.

In FIG. 8(A), a reference symbol 1101 denotes an input image (the referring image 11 and/or the moving image 12) including the liver region and other organ regions. In FIG. 8(B), a reference symbol 1102 denotes an image obtained as a result of extracting the liver region from the image 1101. In FIG. 8(C), a reference symbol 1103 denotes an image obtained as a result of extracting the blood vessel region from the image 1102 from which the liver region has been already extracted. In this manner, the interest region (the liver region and/or the blood vessel region) is extracted from the input image.

The image sampling unit 13 acquires the image region corresponding to the organ region or the tubular region from the interest region extracting unit 19, and executes the sampling processing.

On the other hand, the feature-point detection/correspondence unit 14 executes the feature-point extraction/correspondence processing for the image region corresponding to the organ region (the liver region in this case) and/or the tubular region acquired from each of the interest region extracting units 19 and 20. As a result, the corresponding-point position information 15 is generated, and is outputted to the control grid deforming unit 16 and the registering unit 10. Since the generation of the corresponding-point position information 15 has been described in detail in the first embodiment, a description thereof will be omitted.

Each processing performed by the control grid deforming unit 16 and the registering unit 10 in the second embodiment is basically the same as that in the first embodiment. However, as different from the first embodiment, in the present embodiment, the corresponding-point position information 15 is set to be used also in an image similarity calculating unit 1003 in the registering unit 10. That is, in the second embodiment, in order to improve the registration processing accuracy, the corresponding-point position information 15 acquired from the feature-point detection/correspondence unit 14 is also used for the optimization calculation for maximizing the image similarity between the referring image 11 and the moving image 12.

For example, at the same time with maximization of a mutual information content which is the image similarity, the coordinates of the feature point on the moving image 12 are transformed based on the corresponding-point position information 15 so that the geometrical distance between the transformed coordinates and the corresponding-point coordinates on the referring image 11 is minimized. In the above-described optimization calculation, for example, a cost function C (R, F, U (x)) expressed by Expression (4) is minimized.

$$\begin{matrix} [ Expression 4 ] & \\ C ( R , F , U ( x ) ) = - S ( R , F , U ( x ) ) + μ {\sum }_{x ∈ P} {‖ U ( x ) - V ( x ) ‖}^{2} , & Expression ( 4 )\end{matrix}$$

Here, reference symbols “R” and “F” are the referring image 11 and the moving image 12, and a reference symbol “U(x)” is the movement amount of each pixel obtained by the optimization calculation. A reference symbol “S (R, F, U (x))” represents the image similarity between the referring image 11 and the transformed moving image 12. Also, a reference symbol “P” is a set of feature points obtained by the feature-point detection/correspondence unit 14. A reference symbol “V(x)” is the movement amount of each corresponding point obtained by the feature-point detection/correspondence unit 14. a reference symbol “Σ_{x∈P}∥U(x)−V(x)∥² represents the geometrical distance between the movement amount of each pixel obtained by the optimization calculation and the movement amount of each pixel obtained by the feature-point detection/correspondence unit 14. Further, a reference symbol “μ” is a weight to be experimentally determined.

By the minimization of the cost function C, the optimization calculation for the registration processing can converge more accurately at a higher speed. In this manner, by using the information related to the feature-point position for the calculation of the cost function C for the minimization, a control grid set in the initial setting is also reflected on the optimization calculation, and therefore, large shift from the position of the feature point provided in the initial setting can be limited in the optimization calculation processing. That is, the feature region (the feature region on the image) set in the initial setting can be also considered in the optimization calculation processing.

As described above, the image processing apparatus according to the second embodiment extracts the interest regions which are the registration target from the referring image 11 and the moving image 12, make the extraction and the correspondence of the feature points from these interest regions, and deforms the control grid in registration processing by using the position information of the corresponding points. In this manner, the regions whose feature points are to be extracted and corresponded are limited, and therefore, the processing speed or accuracy can be increased. In addition, the position information of the corresponding points extracted from the interest regions is also used for the optimization calculation in the registration processing. In this manner, the optimization calculation can converge more accurately at a higher speed.

### Third Embodiment

<Outline>

The referring image 11, the interest region on the referring image 11, the registered moving image 18, and the interest region on the registered moving image are superimposed and displayed on a screen. The user who uses the image processing apparatus can perform the edit while checking the display. In the present specification, note that the edit includes addition, correction, and deletion unless particularly limited.

<Configuration and Operation>

In the third embodiment, the registration result and the extraction result of the interest region are superimposed and displayed on the screen. Through the screen, the user visually checks each result, and manually edits the corresponding landmarks (feature points) on the referring image 11 and a moving image 12. In this manner, the registration result can be edited.

Other configurations except for the processing of the edition of the registration result are the same as those of the above-described first and second embodiments, and therefore, the following is the explanation mainly about differences between them. For the descriptive convenience, note that the following is the explanation while exemplifying a configuration obtained by adding a function of editing the registration result to the configuration described as the second embodiment. Obviously, the addition is similarly possible for the configuration described as the first embodiment.

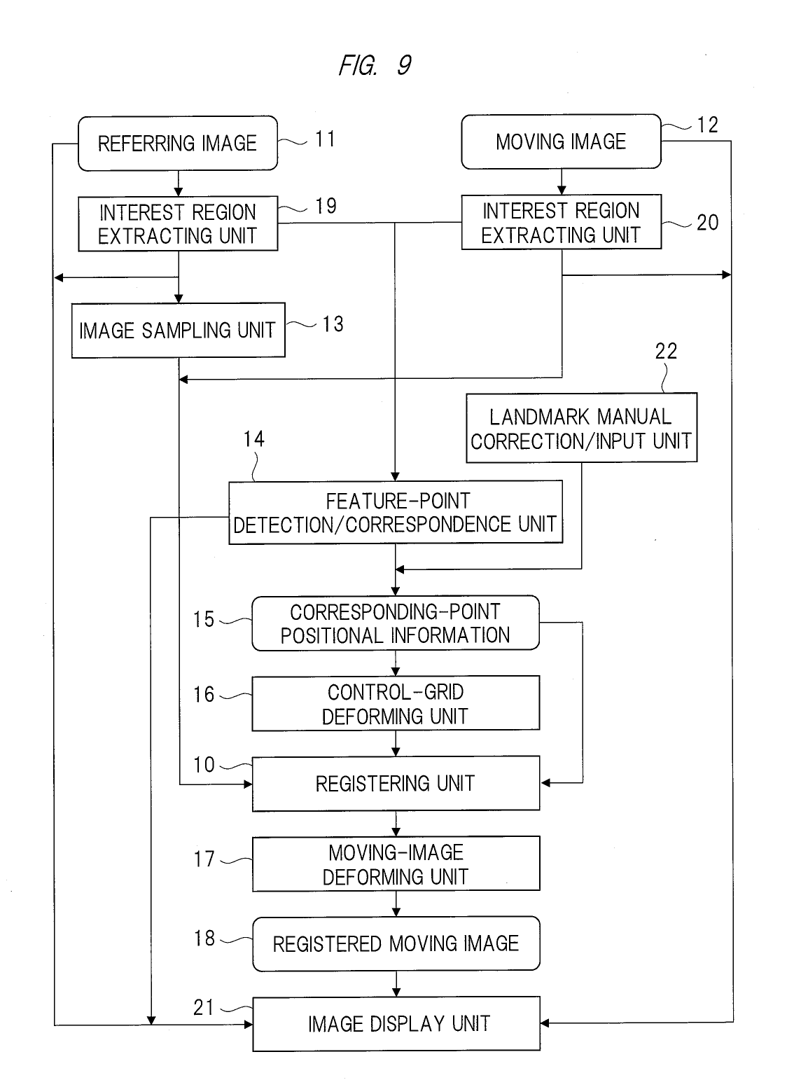

FIG. 9 is a block diagram illustrating a logical configuration of an image processing apparatus according to the third embodiment. The image processing apparatus illustrated in FIG. 9 includes an image display unit 21 and a landmark manual correction/input unit in addition to the configuration described in the second embodiment. Note that each component (1001 to 1004 in FIG. 6) configuring the registering unit 10 is omitted in FIG. 9. However, it should be understood that each component is included therein.

The referring image 11, the moving image 12, the corresponding-point position information 15, and the registered moving image 18 are fed to the image display unit 21. In addition, from the interest region extracting units 19 and 20, information related to the interest region is fed to the image display unit 21. The image display unit 21 superimposes and displays the referring image 11 and the registered moving image 18 in accordance with the fed referring image 11 and the fed registered moving image 18. At this time, the image display unit 21 transparently superimposes and displays the extracted interest region from the referring image 11, on the referring image 11 while changing its color. In addition, the image display unit 21 performs the coordinate transformation of the interest region of the moving image 12 by using the registration result in accordance with the fed moving image 12, the corresponding-point position information 15, and the registered moving image 18, and transparently superimposes the interest region of the moving image 12 on the registered moving image 18 while changing the color. These displays can be combined with each other.

In addition, the image display unit 21 transparently superimposes and displays the referring image 11, its interest region, and the feature point in the interest region. The image display unit 21 also transparently superimposes and displays the moving image 12, its interest region, and the feature point in the interest region. In the transparent superimposing and displaying, the display is performed while changing the colors. As described above, the feature point is superimposed and displayed, so that the results of the feature point extraction and correspondence can be visually checked.

A user such as a doctor checks whether the registration processing has been accurately performed or not while checking the result displayed on the image display unit 21. If it is determined that the registration processing has not been accurately executed, the user manually edits, for example, the landmark determined as not being accurate by using the landmark manual correction/input unit 22. The corresponding-point position information 15 after the edit, which is obtained as the manual editing result, is outputted to the registering unit 10. The registering unit 10 further deforms the deformed control grid by using the corresponding-point position information 15 acquired after the edit, updates the control-point moving amount information 1001 (FIG. 6), and outputs the information to the moving-image deforming unit 17, so that the registration result is corrected.

By the manual edit, for example, the feature-point coordinates on the referring image and/or the feature-point coordinates on the moving image are edited in the corresponding-point pair illustrated in FIG. 16. For example, the feature point coordinates of the corresponding-point pair whose number is 2 are edited. The corresponding-point position information 15 after the edit includes the information of the corresponding-point pair edited as described above.

If the user determines that the registration processing has not been accurately executed even by the above-described manual correction, the user corrects the initial position of the control point in the registration processing by using the corresponding-point position information 15 obtained after the edit which is obtained by the manual edit, and executes the registration processing as similar to those in steps S104 to S110 (FIG. 3) again.

The image display unit 21 is configured by using, for example, the image generating unit 47 illustrated in FIG. 2 and a display device such as the display 52. In addition, the landmark manual correction/input unit 22 can be configured by using hardware such as a circuit device achieving its function, or each function can be configured by execution of a program installed the function by an arithmetic device such as a CPU. In this case, the input device 51 and the input control unit 46 illustrated in FIG. 2 are used for the manual input for the edit.

As described above, in the third embodiment, the referring image 11 and its interest region, and the registered moving image 18 and the interest region of the registered moving image are superimposed and displayed on the screen. In this manner, the user manually edits landmarks while checking the display result, and adjust the control-point moving amount information 1001, so that the registration result can be manually corrected. In addition, when it is determined that the registration processing has not been accurately executed even by the manual edit, the user can correct the initial position of the control point in the registration processing by using the corresponding-point position information 15 obtained by the manual edit, and can execute the registration processing again.

The present invention is not limited to the above-described embodiments, and incorporates various modification examples. The above-described first to third embodiments have been described in detail in order to clearly explain the present invention, and the present invention is not necessarily limited to an embodiment including all the configurations described above. Also, a part of the structure of one embodiment can be replaced with the structure of the other embodiment. Further, the structure of the other embodiment can be added to the structure of one embodiment. Still further, the other structure can be added to/eliminated from/replaced with a part of the structure of each embodiment.

Each configuration, function, processing unit, processing means, and others described above maybe partly or entirely achieved by using hardware by, for example, design in an integrated circuit or others. In addition, each configuration, function, and others described above may be achieved by software by interpretation and execution of a program achieving each function by a processor. The information such as a program, table, and file achieving each function can be stored in a recording medium such as a recording medium such as a memory, hard disk, or SSD (Solid State Drive), an IC card, an SD card, or a DVD.

### SYMBOL EXPLANATION

10 registering unit

11 referring image

12 moving image

13 image sampling unit

14 feature-point detection/correspondence unit

15 corresponding-point position information

16 control-grid deforming unit

17 moving image deforming unit

18 registered moving image

1. An image processing apparatus which performs registration between a plurality of images, comprising:
a registering unit which performs registration between a moving image of the plurality of images and a referring image of the plurality of images, the moving image being deformed by arranging a control grid on the moving image and moving a control point on the control grid;
a corresponding-point setting unit which extracts feature points corresponding to each other from the moving image and the referring image and which obtains corresponding positions to the feature points from the moving image and the referring image, respectively; and
a control-grid deforming unit which deforms and controls the control grid in accordance with the corresponding positions to the feature points.

2. The image processing apparatus according to claim 1,
wherein the registering unit deforms the moving image by moving the control point after the control grid is deformed by the control-grid deforming unit.

3. The image processing apparatus according to claim 2,
wherein the image processing apparatus further includes a processor,
each of the registering unit, the corresponding-point setting unit, and the control-grid deforming unit is achieved by a program executed by the processor.

4. An image processing apparatus which performs registration between a referring image and a moving image, comprising:
a corresponding-point setting unit which extracts feature points from the referring image and the moving image and which searches positions of corresponding points to the feature points from the referring image and the moving image, respectively;
a control-point setting unit which sets a control point on the moving image in order to deform the moving image;
an initial-position setting unit which sets an initial position of the control point by using the positions of the corresponding points;
a transforming unit which deforms the moving image by moving the position of the control point on the moving image;
a sampling unit which extracts a sampling point from the referring image;
an extracting unit which extracts a sampling point on the deformed moving image corresponding to the sampling point on the referring image;
a similarity calculating unit which calculates a similarity between the referring image and the deformed moving image by using the sampling point extracted by the sampling unit and the sampling point extracted by the extracting unit; and
an optimizing unit which calculates a movement amount of a control point, used in the transforming unit, based on the similarity.

5. The image processing apparatus according to claim 4,
wherein the image processing apparatus further includes a region extracting unit which extracts regions to be registration targets from the referring image and the moving image, respectively,
the corresponding-point setting unit extracts feature points from the regions extracted from the referring image and the moving image, respectively, and searches positions of corresponding points to the feature points from the regions, respectively,
the sampling unit extracts a sampling point from the region on the referring image, and
the similarity calculating unit calculates a similarity between the region on the referring image and the region on the moving image by using the extracted sampling point.

6. The image processing apparatus according to claim 5,
wherein the regions extracted by the region extracting unit are interest regions which are interest on the referring image and the moving image.

7. The image processing apparatus according to claim 4,
wherein the corresponding-point setting unit includes:
an input unit which inputs a new corresponding point; and
an editing unit which edits the set corresponding point.

8. The image processing apparatus according to claim 7,
wherein the transforming unit deforms the moving image by moving the position of the control point by using a corresponding point inputted by the input unit.

9. A method of processing an image which performs registration between a referring image and a moving image, comprising the steps of:
a corresponding-point setting step which extracts feature points from the referring image and the moving image and which searches positions of corresponding points to the feature points from the referring image and the moving image, respectively;
a control-point setting step which sets a control point on the moving image in order to deform the moving image;
an initial-position setting step which sets an initial position of the control point by using each of the positions of the corresponding points;
a transforming step which deforms the moving image by moving the position of the control point on the moving image;
a sampling step which extracts a sampling point from the referring image;
an extracting step which extracts a sampling point on the deformed moving image corresponding to the sampling point on the referring image;
a similarity calculating step which calculates a similarity between the referring image and the moving image by using the sampling point on the referring image and the sampling point on the deformed moving image; and
an optimizing step which calculates a movement amount of a control point, used in the transforming step, based on the similarity.

10. The method of processing the image according to claim 9,
wherein the corresponding-point setting step, the control-point setting step, the initial-position setting step, the transforming step, the sampling step, the extracting step, the similarity calculating step, and the optimizing step are achieved by making a server installed in a data center execute a program, and an image processing result is transmitted to a client terminal connected to the server.
